(19) United States
(12) Patent Application Publication
(10) Pub. No.: US 2024/0375857 A1
(43) Pub. Date: Nov. 14, 2024

(54) ANIMAL WASTE STORAGE DEVICE

(71) Applicant: Balloon Innovations, Inc., Westminster, CO (US)

(72) Inventors: Christopher J. Wicken, Golden, CO (US); Alex J. Fountain, Evergreen, CO (US)

(21) Appl. No.: 18/657,116

(22) Filed: May 7, 2024

Related U.S. Application Data
(60) Provisional application No. 63/500,652, filed on May 8, 2023.

(51) Int. Cl. B65F 1/06; B65F 1/16

(52) U.S. Cl. CPC B65F 1/062; B65F 1/1615

(57) ABSTRACT

The present invention describes an animal waste collection and storage device configured to temporarily secure a bag containing animal waste for later disposal. In one embodiment, the device of the invention can be securable to a leash, and further include an ergonomic handle configured to allow a user to use the device as an extension of the leash, or leash handle when walking an animal.

### CROSS-REFERENCES TO RELATED APPLICATION

This application claims the benefit of and priority to U.S. Provisional Application No. 63/500,652, filed May 8, 2023. The entire specification and figures of the above-referenced application is hereby incorporated in its entirety by reference.

### TECHNICAL FIELD

The present invention is directed to the field of waste collection and storage, and specifically systems and devices for the temporary collection and storage of animal waste.

### BACKGROUND

In many communities, it is unlawful to allow the deposit of animal waste on public property or another's private property. Animal waste, primarily fecal matter from dogs, is unsanitary and is considered a nuisance when it is not cleaned up after. However, an animal owner who must clean up after their pet faces the unpleasant task of removing the waste and disposing of it. Often, this is required in remote locations, such as in a park or on a neighbor's yard and proper disposal isn't immediately available. The owner is forced to use a waste container, usually consisting of a plastic bag, to collect the waste and store it until proper disposal is available. Once the waste is collected, the animal's owner may still be subject to the odor of the waste for the remainder of the excursion, or the visual sight of the waste through the bag. These unpleasant aspects of cleaning up animal waste often result in owners neglecting to clean up the waste, or the waste being improperly disposed of. As such, there exists a long-felt need for an animal waste storage device that is lightweight, and convenient for user to take with them when they walk their pets, but that can also effectively store animal waste and the like.

### SUMMARY OF THE INVENTION

In one aspect, the present invention is directed to novel systems, methods and devices for an improved animal waste collection and temporary storage. In one preferred aspect, the animal waste storage device of the invention can include a collection body configured to temporarily secure a bag containing animal waste within a collection channel secured by one or more end-caps for later disposal an adaptor. The collection body of the invention may further include a handle and adaptor configured to a leash, or alternatively secure a fastener that can be secured to a leash or other article for easy transport.

In another aspect, the collection channel can include a partition surface separating the collection body into at least two separate compartments. In a first compartment, clean and unused bags for animal waste collection can be stored. In a second compartment, soiled bags containing animal waste can be secured and separated from the first by the partition surface,

Additional aspects of the invention may be evident from the detailed descriptions, figures and claims provided herein.

### BRIEF DESCRIPTION OF DRAWINGS

FIGS. 1A-E—(A) shows a top view of an animal waste storage device in one embodiment thereof; (B) shows a perspective view of an animal waste storage device in one embodiment thereof; (C) shows a side view of an animal waste storage device in one embodiment thereof; and (D) shows a front view of an animal waste storage device in one embodiment thereof.

FIG. 2—shows a side view of a disarticulated animal waste storage device in one embodiment thereof.

FIG. 3—shows a side view of a disarticulated animal waste storage system with a bag containing animal waste being inserted into the channel of the collection body in one embodiment thereof.

FIG. 4—shows a side view of an animal waste storage device having end caps secured to each of the terminal ends of the collection body in one embodiment thereof.

FIGS. 5A-C—(A) shows a pair of exemplary end caps configured to be secured to the terminal ends of the collection body in one embodiment thereof; (B) shows an exemplary fastener in one embodiment thereof; and (C) shows an exemplary collection body having an integral handle positioned opposite an adaptor component in one embodiment thereof.

### DETAILED DESCRIPTION OF THE INVENTION

The present invention includes a variety of aspects, which may be combined in different ways. The following descriptions are provided to list elements and describe some of the embodiments of the present invention. These elements are listed with initial embodiments; however, it should be understood that they may be combined in any manner and in any number to create additional embodiments. The variously described examples and preferred embodiments should not be construed to limit the present invention to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

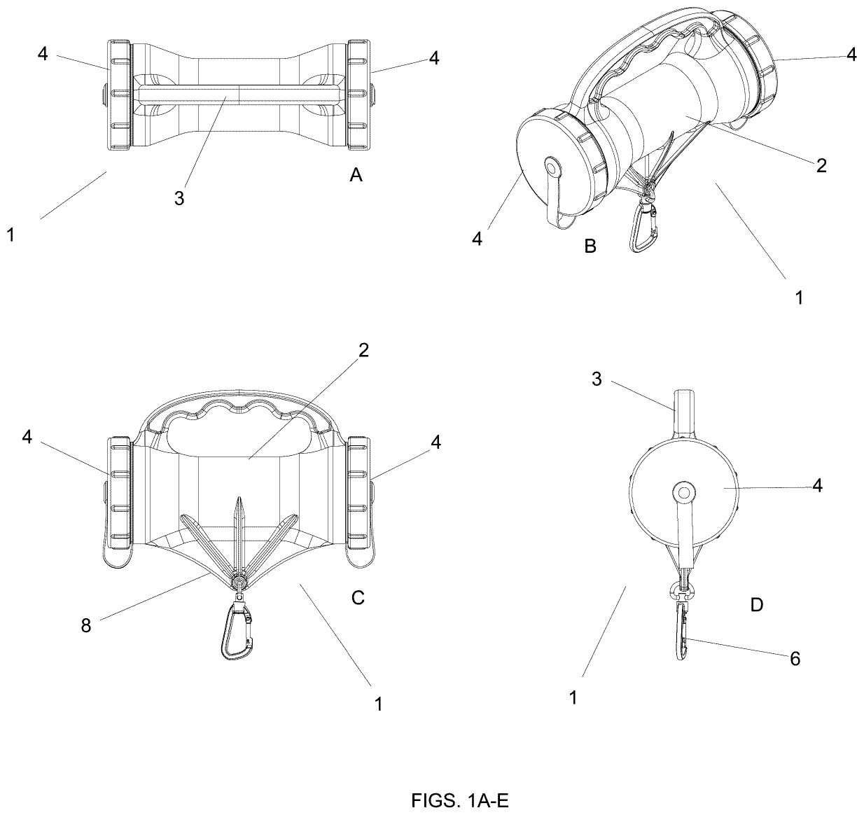

The present invention is directed to an animal waste storage device (1) configured to collect and secure animal waste, and preferably animal excrement positioned within a separate bag (5) or container, as well as litter and other miscellaneous items. Generally referring to FIG. 1, the animal waste storage device (1) of the invention include a collection body (2). In this embodiment, the collection body (2) can include an elongated tube forming a collection channel (9) defining an internal storage compartment. The collection body (2) of the invention can be an integral or separable components and can further be formed from a rigid material, such as plastic, or other thermoplastic compounds that can be used in traditional molding processed.

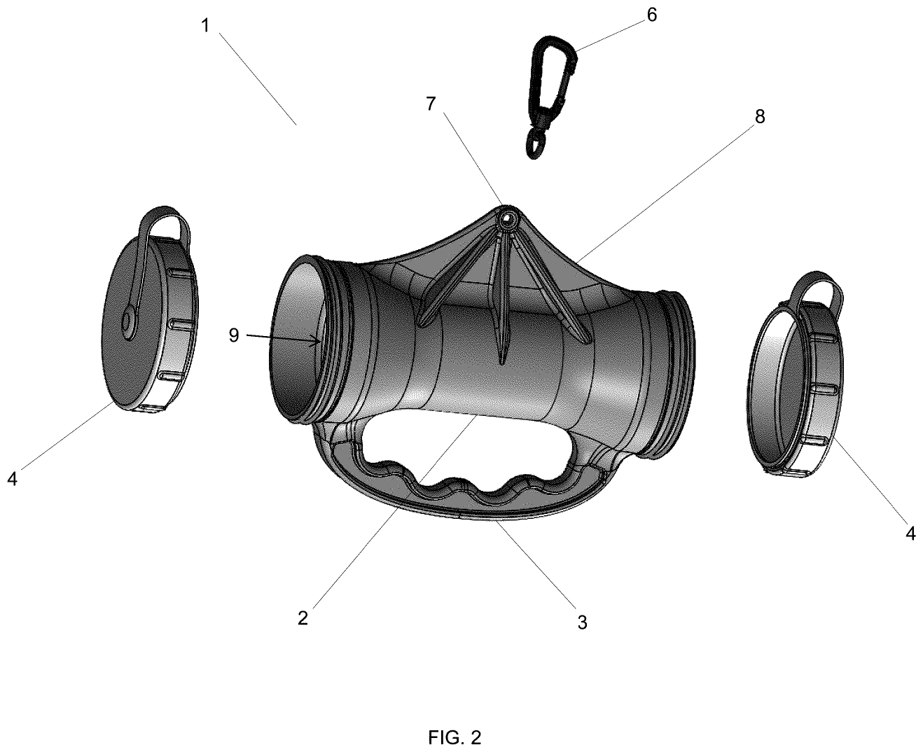

Again, referring to FIGS. 1-5, in this embodiment the collection channel (9) defining an internal storage compartment can be a continuous collection channel (9) spanning the length of the collection body (2) and can further be secured at both ends by an end cap (4). As shown in FIG. 2, the end caps (4) can be secured to the terminal ends of the collection body (2), for example through a threaded coupling. This configuration allows for the easy disposal and cleaning of waste within the internal collection channel (9) of the collection body (2). For example, in this embodiment, one of the end caps (4) can be removed and positioned vertically thereby allowing a bag (5) containing waste, or other trash to be ejected by gravity without the user having to reach into the collection channel (9). Moreover, the opposing end cap (4) can also be removed allowing the collection body (2) to be cleaned, for example by running water or other cleaning solution through the collection channel (9). Moreover, a user can manually clean the inside of the collection body (2) by inserting their hand through either end with a rag, cleaning solution of other similar cleaning implement. In alternative embodiments, the collection channel (9) defining an internal storage compartment can be a non-continuous collection channel (9) spanning the length of the collection body (2) and can further be secured at one end by a single end cap (4).

Naturally, the end cap coupling shown in the figures is exemplary only, as additional method of coupling the end cap (4) to the collection body (2) are contemplated within the invention. For example, in certain embodiments, one or more end caps (4) of the invention can be secured to the collection body (2) through a slide coupler, a twist coupler, a quick release coupler, a pin coupler and the like.

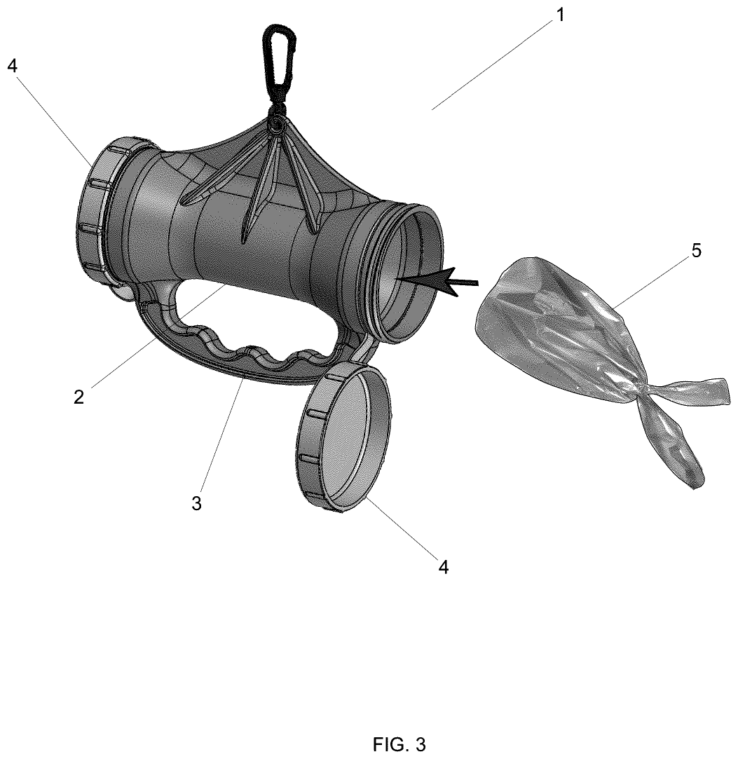

Referring again to FIG. 3, the collection body (2) of the invention can be configured to temporarily secure one or more bags (5) containing animal waste, or other miscellaneous objects, such a litter and the like, within a collection channel (9) for later disposal. As noted above, the collection channel (9) can include a continuous collection channel (9) spanning the length of the container body (2). In certain embodiments, a partition surface (not shown) can be positioned within the collection channel (2), horizontally bisecting and separating the collection body (2) into at least two separate compartments. In one embodiment, the partition surface (not shown) of the invention can include an integral partition separating the section and separating the collection body (2) into at least two separate compartments, while in alternative embodiments, the partition surface (not shown) of the invention can include an removable partition that can be inserted into the collection body (2) and secured into a position thereby separating the section and separating the collection body (2) into at least two separate compartments.

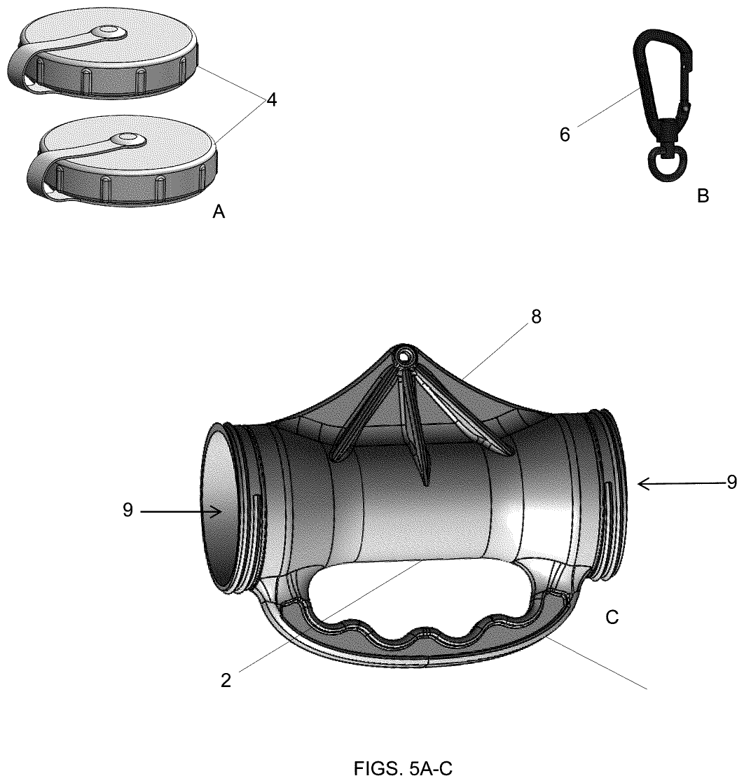

As shown in FIG. 5, one of the compartments generated by the partition surface (not shown) can be configured to secure a bag (5) containing animal waste, while the compartment can be configured to secure excess clean bags for collecting animal waste, as well as personal items, such as a wallet, keys or animal food. In this manner, the soiled animal waste can be secured in a bag (5) and further separated from clean bags (5) for future use, as well as personal items.

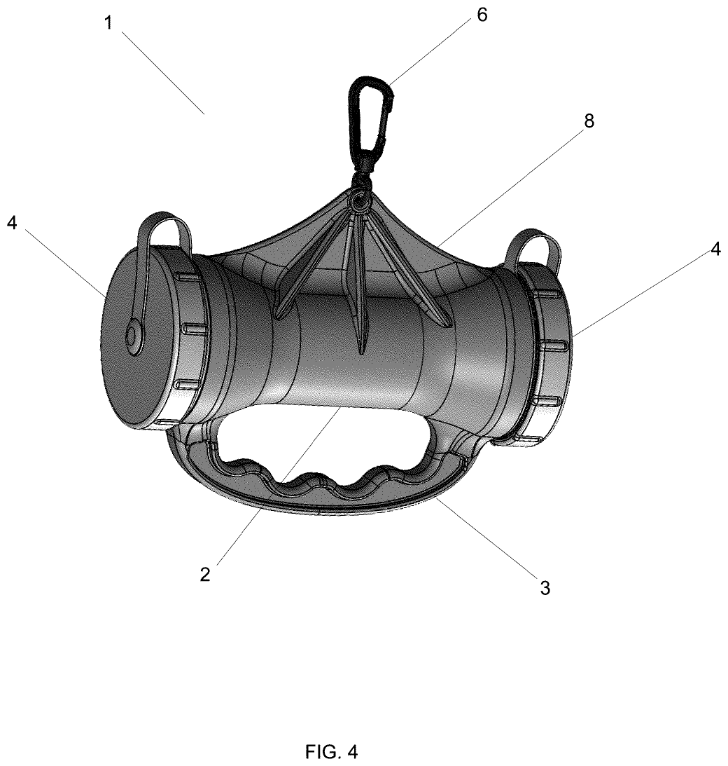

In one preferred embodiment, the waste disposal device (1) can form a leash extension device. For example, as shown in FIG. 4, the collection body (2) can comprise a handle (3), which can be a separable or integral components with the collection body (2). This handle can be positioned along the top surface of the collection body (2) and can further be positioned opposite an adaptor (8). In this embodiment, the adaptor (8) of the invention can include a separable or integral components configured to secure a leash (not shown). Alternatively, the adaptor (8) of the invention can secure a fastener (6), for example through a fastener aperture (7) position on the leading edge of the adaptor (8) which can further be secured to a leash. In this embodiment, a user can grip the handle (2) of the waste disposal device (1) that is further secured to a leash, for example through an adaptor, or a fastener (6) such that the device of the invention operates as an extension of the leash. In this configuration, the waste disposal device (1) does not need to be separately carried or attached to the user, or other device.

However, it should be noted that in alternative embodiments, should a user desire, the waste disposal device (1) can be attached to a user, for example by securing the fastener (6) to an article of clothing such as a belt, backpack, or other article of clothing or carrier. The waste disposal device (1) can further be attached to a separate device or component, for example by securing the fastener (6) to a separate device, such as a bicycle, stroller, and the like.

All embodiments discussed herein are merely illustrative and should not be construed to limit the scope of the inventive technology consistent with the broader inventive principles disclosed. As may be easily understood from the foregoing, the basic concepts of the present inventive technology may be embodied in a variety of ways. It generally involves apparatus, systems, methods, and techniques as well as devices to accomplish an animal waste storage device having as generally claimed herein. In this application, the improved techniques, including novel and unique methods and apparatus for collecting and storing animal waste and the like are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the inventive technology and may not explicitly show how each feature or element can actually be representative of a broader function or of a great variety of alternative or equivalent elements. Again, these are implicitly included in this disclosure. Where the inventive technology is described in device-oriented terminology, each element of the device implicitly performs a function. Apparatus claims may not only be included for the device described, but also method or process claims may be included to address the functions the inventive technology and each element performs. Neither the description nor the terminology is intended to limit the scope of the claims that will be included in any subsequent patent application.

It should also be understood that a variety of changes can be made without departing from the essence of the inventive technology. Such changes are also implicitly included in the description. They still fall within the scope of this inventive technology. A broad disclosure encompassing the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the inventive technology both independently and as an overall system.

Further, each of the various elements of the inventive technology and claims may also be achieved in a variety of manners. Additionally, when used or implied, an element is understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “coupler” should be understood to encompass disclosure of the act of “coupling”—whether explicitly discussed or not—and, conversely, were there effectively disclosure of the act of “coupling”, such a disclosure should be understood to encompass disclosure of a “coupling method and/or technique, and or device.” Such changes and alternative terms are to be understood to be explicitly included in the description.

Thus, the applicant(s) should be understood to have support to claim and make a statement of invention to at least: i) each of the methods, improvements and/or devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible. The use of the phrase, “or any other claim” is used to provide support for any claim to be dependent on any other claim, such as another dependent claim, another independent claim, a previously listed claim, a subsequently listed claim, and the like.

Finally, any claims set forth at any time are hereby incorporated by reference as part of this description of the inventive technology, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. An animal waste storage device comprising:
a collection body an adaptor configured to secure a fastener;
an end-cap securable to the end of the collection body; and
wherein said collection body is configured to temporarily secure a bag containing animal waste within a collection channel for later disposal.

2. The device of claim 1, further comprising a partition surface positioned within said collection channel separating the collection body into at least two separate compartments.

3. The device of claim 1, wherein one of the compartments is configured to secure the bag containing animal waste.

4. The device of claim 1, wherein one of the compartments is configured to secure excess bags for collecting animal waste.

5. The device of claim 1, further comprising wherein the collection body comprises an end cap secured to each terminal end of the collection body.

6. The device of claim 1, further comprising an animal leash securable to said fastener and/or adapter.

7. The device of claim 1, wherein said animal waste storage device comprises a plastic animal waste storage device.

8. The device of claim 1, further comprising a handle secured to said collection body.

9. The device of claim 8, wherein said handle comprise an integral handle.

10. A system for animal waste collection and storage comprising:
a collection body an adaptor configured to secure a fastener;
an end-cap securable to the end of the collection body;
an animal waste bag; and
wherein said collection body is configured to temporarily secure a bag containing animal waste within a collection channel for later disposal.

11. The device of claim 10, further comprising a partition surface positioned within said collection channel separating the collection body into at least two separate compartments.

12. The device of claim 10, wherein one of the compartments is configured to secure the bag containing animal waste.

13. The device of claim 10, wherein one of the compartments is configured to secure excess bags for collecting animal waste.

14. The device of claim 10, further comprising wherein the collection body comprises an end cap secured to each terminal end of the collection body.

15. The device of claim 10, further comprising an animal leash securable to said fastener and/or adapter.

16. The device of claim 10, wherein said animal waste storage device comprises a plastic animal waste storage device.

17. The device of claim 10, further comprising a handle secured to said collection body.

18. The device of claim 17, wherein said handle comprise an integral handle.

19. The device of claim 8, wherein said handle comprise an integral handle.

20. An animal waste collection and storage device comprising:
a collection body an adaptor configured to secure a fastener, wherein said fastener comprises a leash, or a fastener configured to be secured to the leash;
a handle integral with said collection body;
an end-cap securable to the end of the collection body;
an animal waste bag; and
wherein said collection body is configured to temporarily secure a bag containing animal waste within a collection channel for later disposal.
